(19) United States
(12) Patent Application Publication
(10) Pub. No.: US 2009/0231078 A1
(43) Pub. Date: Sep. 17, 2009

(54) Switching Transformer

(75) Inventor: Osamu Watanabe, Saitama (JP)

Correspondence Address: DENNIS G. LAPOINTE;LAPOINTE LAW GROUP, PL, PO BOX 1294, TARPON SPRINGS, FL, 34688-1294, US

(73) Assignee: TAMURA CORPORATION, Tokyo (JP)

(21) Appl. No.: 12/096,032

(22) PCT Filed: Dec. 5, 2006
(86) PCT No.: PCT/JP2006/324235

§ 371 Date: Aug. 20, 2008

(30) Foreign Application Priority Data
Dec. 5, 2005 (JP) 2005-350159

(51) Int. Cl. H01F 27/29; H01F 41/02

(52) U.S. Cl. 336/192; 29/605

(57) ABSTRACT

There is provided a switching transformer which enables material costs to be reduced while the performance to be improved, permitting cost and size reductions, and which is suitable for mass production by ensuring good assemblability. Instead of using a conventional coil bobbin having a winding drum part, a center-leg-having core 3 having the shape of a substantially inverted T is integrated with a terminal block 1 having a substantially flat upper surface and terminals implanted in a lower surface. An electric wire 6a is wound around the outer circumference of a center-leg core 3b protruding from the upper surface 1a of the terminal block 1, thereby a coil 6 is mounted. A C-type core 4 is built into this assembly to form a switching transformer.

### TECHNICAL FIELD

The present invention relates to a small switching transformer.

### BACKGROUND ART

Conventionally, this type of switching transformer generally uses a coil bobbin in which there is formed, at an end of a hollow and cylindrical winding drum part, a terminal block having terminals. And, the switching transformer is configured with coils wound around the outer circumference of the winding drum part of this coil bobbin, and with a core having a center leg inserted in the winding drum part.

In the above-described conventional switching transformer with a configuration in which electric wires are wound around the outer circumference of the hollow winding drum part of a coil bobbin, as described above, there is a slight gap between the outer circumference of the center leg of the core inserted into the winding drum part and the inner circumferential surface of the winding drum part. Further, due to the thickness of the winding drum part of approximately 1 mm, the coils are distanced from the center leg of the core, and the coupling factor is diminished, which is not preferable in view of the performance.

Furthermore, the circumferential length of the winding drum part around which the coils are wound is increased in proportion to the sum of the thickness of the winding drum part of the coil bobbin and the gap between the center-leg of the core and the winding drum part of the coil bobbin. Therefore, the consumption of the electric wires, insulating tapes and so on to be wound around the outer circumference of the winding drum pan increases, in proportion to which the cost gets higher, leading to a considerably high cost in the mass production of the products.

Today, when the price competition is severe, the costs have to be reduced, while performance be improved, as well as size reductions be accomplished, in order for a company to get ahead of other competing companies.

For improving the coupling factor by shortening the distance between the center leg and the coils, for reducing the costs by reducing the consumption of the electric wires and the insulating tapes, and for accomplishing size reductions, it is conceivable to wind the electric wires directly on the outer circumference of the center-leg core.

As such a configuration, there is a coil part as shown in FIG. 10 (Japanese Patent Laid-Open No. 10-92655),

In this coil part, an insulating plate 100 having a plurality of electrode parts is bent and mounted to a coil-placing bottom portion 102 of a core 101, a coil 103 is provided on the insulating plate 100 that covers the coil-placing bottom portion, and leads of the coil 103 are connected to electrode parts 104, thereby a winding drum part of a coil bobbin between a center-leg core and a coil is made unnecessary.

Patent Document: 1 Japanese Patent Application, Laid-Open No. 10-92655

However, the above-described conventional example had a problem that, in attaching the insulating plate 100, it is necessary to bend and mount the insulating plate 100 to the coil-placing bottom portion 102, and hence it requires the bending process as well as the work of attaching the electrodes 104 as terminals respectively at four places of the insulating plate 100, so, the assembling is very complicated.

Furthermore, because side-leg cores 101b are provided in a standing manner respectively on the outer side of a center-leg core 101a of the core 101 on which the coil 103 is to be provided, these side-leg cores 101b constitute an obstacle that prevents winding the coil 103 directly on the outer circumference of the center-leg core 101a while rotating the center-leg core 101a using a winding machine. In this respect, also, the conventional example had a problem that the workability is very low.

The present invention has been proposed in view of the above-described circumstances, and the object of the invention is to provide a switching transformer, which is suitable for mass production, and in which the material costs are cut down while the performance is improved, the cost and size are reduced and the assemblability is improved.

### DISCLOSURE OF THE INVENTION

The method of manufacturing a switching transformer of the present invention is characterized in comprising the steps of; inserting a center-leg core of a center-leg-having core which has a substantially inverted T-shaped section, into a hole for inserting the center-leg core formed in a center part of a terminal block which has a substantially flat upper surface and terminals implanted in a lower surface thereof, to integrate the terminal block and the center-leg-having core; rotating the center-leg core to wind an electric wire around an outer circumference of the center-leg core protruding from the upper surface of the terminal block, to mount a coil; and subsequently, assembling the switching transformer by placing, from the upper surface side of the terminal block, a substantially Π-shaped, side-leg-having C-type core having side leg cores formed on both end portions of a connecting part, making an inner surface of the connecting part abut to a top end surface of the center leg core, and connecting bottom faces of the side leg cores with both end portions of a top surface of a core body of the center-leg-having core via a gap.

The above-described method of manufacturing a switching transformer further comprises, winding insulating paper on the outer circumference of the center-leg core, winding margin tapes respectively on both end portions of the center-leg core, and winding the coil between the margin tapes.

Furthermore, the above-described method of manufacturing a switching transformer comprises fixing the terminal block having the center-leg-having core to a rotatable first jig, making the top end of the center-leg core be supported by a second jig, and rotating the terminal block through the first jig, to wind the electric wire around the outer circumference of the center-leg core.

The switching transformer is characterized in comprising; a terminal block whose upper surface is formed substantially flat, in a side portion of a lower surface of which there are implanted terminals, and in a center portion of which there is formed a hole; a substantially-inverted-T-shaped center-leg-having core, whose core body is positioned on a lower face of the terminal block, and in which a center-leg core is formed on a center part of the core body, and the center-leg core is inserted through the hole and protruding from the upper surface of the terminal block; a coil wound around an outer circumference of the center-leg core; and a substantially Π-shaped, side-leg-having C-type core, which is incorporated from the upper surface side of the terminal block so as to straddle the coil, and in which bottom surfaces of side leg cores formed on both end portions of a connecting part are connected to both end portions of a top surface of the core body of the center-leg-having core via a gap, and an inner surface of the connecting part is abutted to a top end surface of the center-leg core.

In the above-described switching transformer, a rib is formed around the hole of the terminal block through which the center-leg core is to be inserted.

In the above-described switching transformer, insulating paper is wound around the outer circumference of the center-leg core which is inserted into the hole of the terminal block, a margin tape is wound on each of both end portions of the center-leg core protruding from the upper surface of the terminal block, and the coil is wound between the margin tapes.

In the above-described switching transformer, a substantially rectangular notch is formed in each end face of the terminal block, each of end portions of the core body of the center-leg-having core is positioned on each of the notches, and a bottom face of each of the side-leg cores is connected to each of the end portions via a gap.

According to the present invention, since the coils are wound around the outer circumference of the center-leg core protruding from the upper surface of the terminal block 1, the assembling workability is improved and the distance from the center part of the center-leg core to the coil is made shorter, leading to an increase in the coupling factor, as a result of which, there are effects that the efficiency is improved and power is obtained. In addition to this advantage of an increase in productivity and performance, the nonuse of a coil bobbin with a winding drum part ensures a small size, and the consumption of electric wires, insulating tapes and so on decreases. In addition, because the terminal block does not have a winding drum part, the amount of the material for the terminal block is reduced, enabling the costs to be reduced.

Because the center-leg core is supported with the rib, it is possible to stably support the center-leg core.

Furthermore, because the side-leg cores of the C-type core are disposed in the notches of the terminal block to ensure that these side-leg cores do not project outside of the terminal block, size reduction is made possible.

### BRIEF DESCRIPTION OF THE DRAWINGS

FIG. 1 is an exploded perspective view of an embodiment of the present invention;

FIG. 2 is an explanatory diagram showing how a terminal block used in an embodiment of the present invention is incorporated into a center-leg-having core;

FIG. 3 is a perspective view of an assemble in which a terminal block and a center-leg-having core used in an embodiment of the present invention, are integrated;

FIG. 4 is a perspective view of a state in which a coil has been wound on the above-described assembly;

FIG. 5(a) is a diagram showing how an assembly is attached to a jig, and FIG. 5(b) is a diagram showing how an electric wire is wound on a center-leg core of a terminal block to which a jig is attached, to wind a coil;

FIG. 6 is an explanatory diagram showing how a C-type core is integrated with a terminal block on which a coil is wound;

FIG. 7 is a perspective view of an assembled switching transformer of the present invention;

FIG. 8 shows a section taken along line A-A in FIG. 7;

FIG. 9 shows the relationship between the coupling factor and the change of the gap of the core; and

FIG. 10 is an exploded perspective view of a conventional example.

### DESCRIPTION OF REFERENTIAL NUMERALS

1 Terminal block

1a Upper surface

1b Leading groove

1c Notch

1d Hole

1e Rib

1f Partition wall

1g Core body housing portion

2 Terminal

3 Center-leg-having core

3a Core body

3b Center-leg core

4 C-ape core

4a Connecting part

4b Side-leg core

5 Margin tape

6 Coil

6a Electric wire

7 First jig

8 Second jig

9 Insulating tape

### BEST MODE FOR CARRYING OUT THE INVENTION

Embodiments according to the present invention will be described below with references to the drawings.

### Embodiment 1

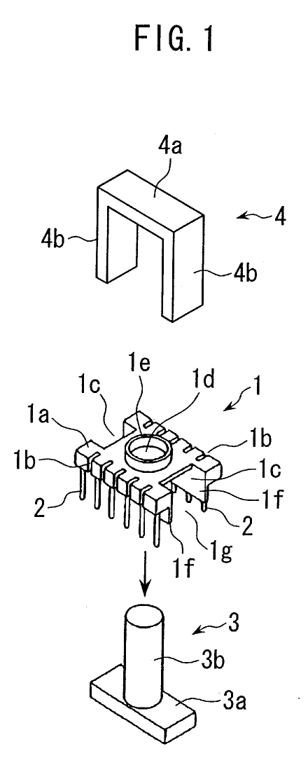

FIG. 1 is an exploded perspective view of Embodiment 1 of the present invention.

Without an use of a conventional coil bobbin with a winding drum part, the switching transformer of the present invention is configured with, as its main components, a terminal block 1 which has terminals 2 at both end portions of the lower surface in the illustrated condition and whose upper surface 1a is almost flat, a center-leg-having core 3 which is incorporated from the lower side in the illustrated condition and has a substantially T-shaped vertical cross section, and a substantially inverted U-shaped, side-leg-having, C-type core 4 that is incorporated from the upper side and whose side legs are placed on respective end portions of the top surface of the core.

The center-leg-having core 3, which is made of ferrite, is composed or an I-shaped core body 3a and a cylindrical center leg 3b provided in a standing manner on the center part of the top surface of this core body 3a.

The C-type core 4 is also made of ferrite, and side-leg cores 4b are provided respectively at both ends of an I-shaped connecting part 4a.

The terminal block 1 is formed substantially rectangular as viewed from the upper side. In both side portions, there are formed at appropriate intervals a plurality of leading grooves 1b for guiding the lead wires (not shown) of the coil, and a plurality of terminals 2 are implanted in a lower surface.

In each of both ends of the terminal block 1, there is formed a substantially rectangular notch 1c for disposing each side-leg core 4b adjacently on the top surface of each end portion of the core body 3a of the center-leg-having core 3. The shape of this notch 1c corresponds to the shape of the side-leg core 4b.

Furthermore, in the middle part of the terminal block 1, there is formed a round hole 1d through which the center-leg core 3b is to be inserted to protrude to the side of the upper surface 1a, and around the hole 1d is formed a ring-shaped rib 1e for stably supporting the inserted center-leg core 3b. This rib 1e is formed on the upper surface 1a of the terminal block 1.

On the lower surface of the terminal block 1, there are formed rib-like partition walls 1f, which are spaced from and facing each other, and a core body housing portion 1g that houses the core body 3a of the center-leg core 3 is formed by the pair of partition walls 1f. The partition walls 1f are formed on the inner side of the terminals 2.

Next, the assembling method will be described.

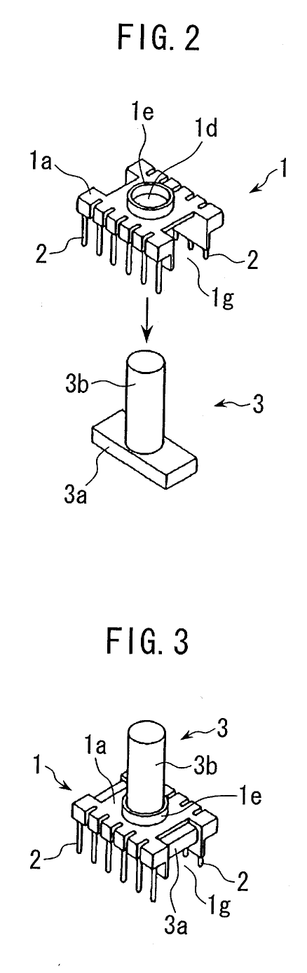

First, the terminal block 1 is moved downward to the center-leg-having core 3 side as indicated by the arrows in FIGS. 1 and 2, the center-leg core 3b is inserted into the hole 1d of the terminal block 1 as shown in FIG. 3, the core body 3a is disposed in the core body housing portion 1g, and the center-leg-having core 3 is incorporated into the terminal block 1, whereby both are integrated. Alternatively, the center-leg-having core 3 may be moved upward to be incorporated into the terminal block 1.

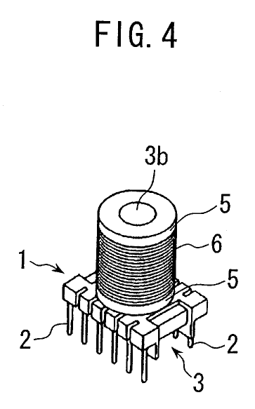

Next, as shown in FIG. 4, margin tapes 5 are wound around the upper and lower portions of the center-leg core and a coil 6 is wound between the margin tapes 5.

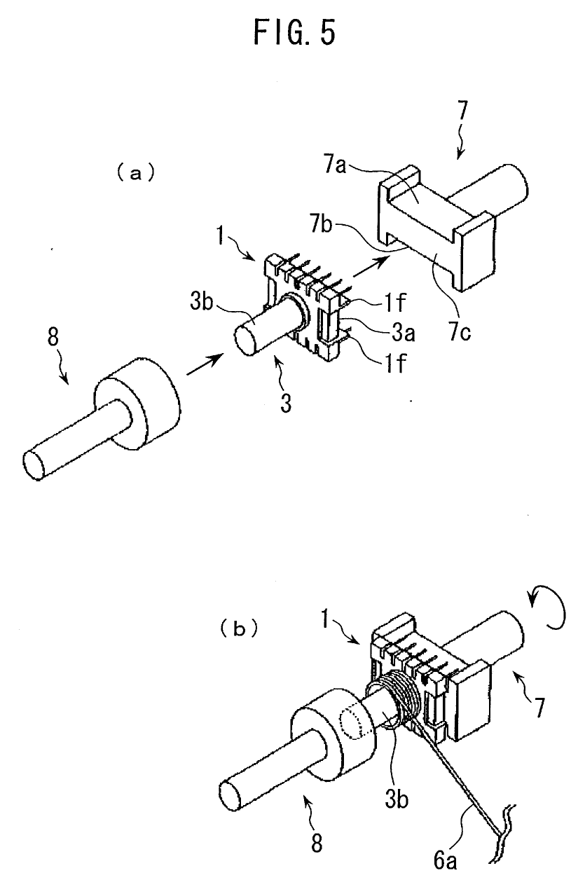

As shown in FIG. 5(a), in winding the coil 6, the terminal block 1 with the center-leg-having core 3 incorporated therein is set on a first jig 7 which is capable of rotation and connected to a motor (not shown), and a second jig 8 is set on a top end of the center-leg core 3b, to support the center-leg core 3b.

In the setting of the first jig 7, the partition walls 1f of the terminal block 1 sandwich and support the top surface 7a and the bottom surface 7b of the main body of the first jig 7, the front surface 7c of the main body of the first jig is abutted and held to the bottom surface of the core body 3a of the T-shaped, center-leg-having core 3. Because the core is a T-shaped core being incorporated into the terminal block 1, not being an I-shaped core consisting only of a center-leg core, it can be firmly fixed to the first jig 7 by the core body 3a part. And as shown in FIG. 5(b), by rotating the first jig 7 as indicated by the arrow, an electric wire 6a is wound around the outer circumference of the center-leg core 3b, thereby the coil 6 can be mounted.

In the present invention, because no side-leg core is present on either side of the center-leg-having core 3, it is possible to wind the coil 6 directly on the outer circumference of the center-leg core 3b easily and speedily as described above, so, the assemblability is improved, and the coupling factor can be improved, because no winding drum part of a coil bobbin is interposed between the coil 6 and the center-leg core 3b.

Furthermore, because the circumferential length is shortened by the elimination of the winding drum part, the consumption of the electric wire 6a is reduced, which leads to a cost reduction.

In here, as is generally known, an insulating tape (not shown) is wound on the outer circumference of the center-leg core 3b, before the winding of the electric wire 6a. Also, margin tapes 5 are wound on the upper and lower portions of the center-leg core 3b protruding from the top surface 1a of the terminal block 1. However, in FIG. 5(b) showing how the coil is wound, the illustration of the margin tapes 5, the insulating paper and the like is omitted. Also the insulating tape and the margin tapes 5 can be wound around the center-leg core 3b by using the first jig 7.

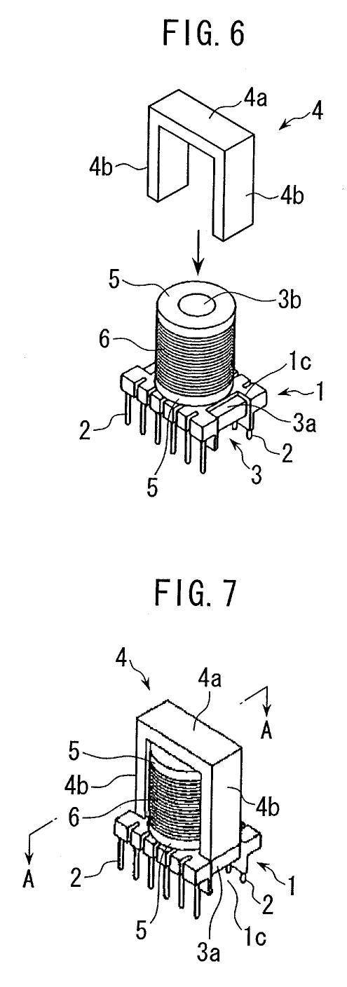

After the mounting of the coil 6 on the terminal block 1, the C-type core 4 having the side-leg cores 4b is integrated, with the bottom faces of the side-leg cores 4b being arranged to face the respective end portions of the top surface of the core body 3a of the center-leg-having core 3, located on the notches 1c of the terminal block 1, and with the top end face of the center-leg core 3b being made abutting to the inner surface of the connecting part 4a of the C-type core 4, thereby a switching transformer is assembled, as shown in FIGS. 6 and 7.

In here, though not particularly illustrated, magnetic gaps can be easily provided by providing insulating paper or a spacer made of resin between the bottom faces of the side-leg cores 4b of the C-type core 4 and the top surface of the core body 3a of the center-leg-having core 3 facing these bottom faces, and the side-leg cores 4b and the core body 3a can be connected through these gaps.

In order to prevent the coming apart of this assembly, for example, a tape (not shown) may be wounded on the outer circumference of the core composed of the center-leg-having core 3 and the C-type core 4, or the outer portion of an abutting faces may be bonded.

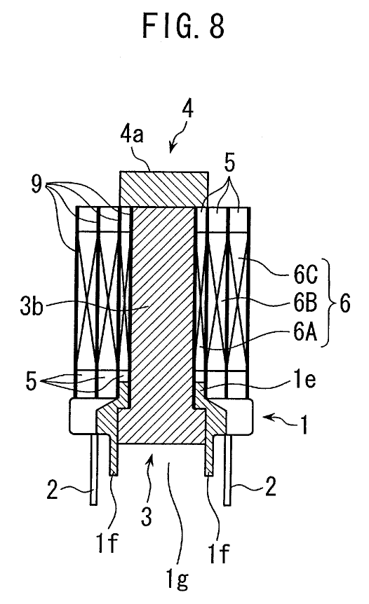

FIG. 8 shows a section taken along line A-A in FIG. 7. In this embodiment, the coil 6 is composed of an inner winding 6A, a middle winding 6B and an outer winding 6C. In its assembling, an insulating tape 9 is first wound on the outer circumference, a margin tape 5 is wound on the outer circumference of the bottom end portion of the center-leg core 3b protruding from the rib 1e of the terminal block 1, and a margin tape 5 is wound also on the upper end portion of the center-leg core 3b. And the inner winding 6A is wound between these upper and lower margin tapes 5, and an insulating tape 9 is wound on the outer circumference of the inner winding. Next, a margin tape 5 is wound on each of both end portions of the insulating tape, the middle winding 6B is wound between the margin tapes, and an insulating tape 9 is wound on the outer circumference of the middle winding. Next a margin tape 5 is wound on each of both end portions, the outer winding 6C is wound between the margin tapes, and an insulating tape 9 is wound on the outer circumference of the winding after the completion of the winding.

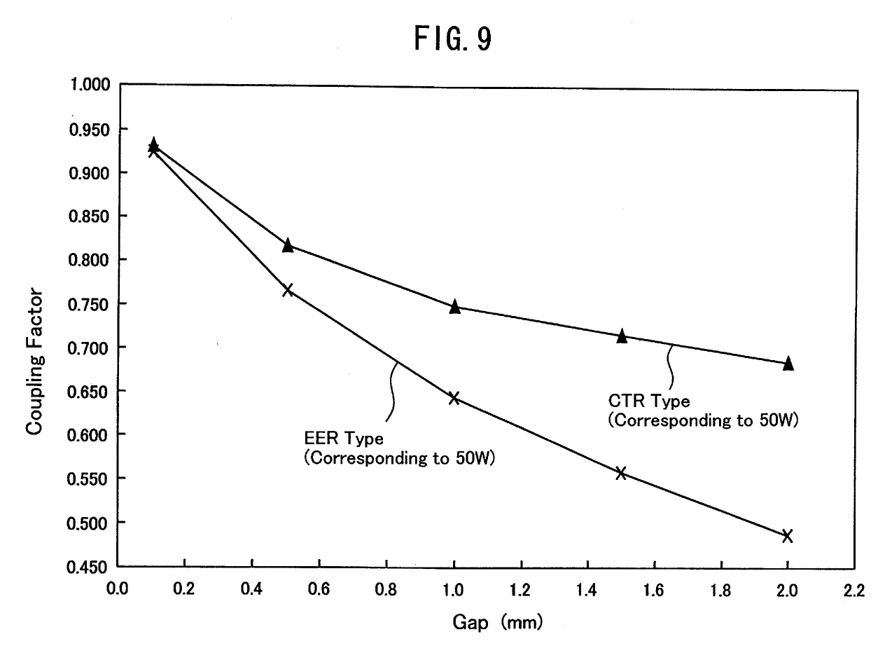

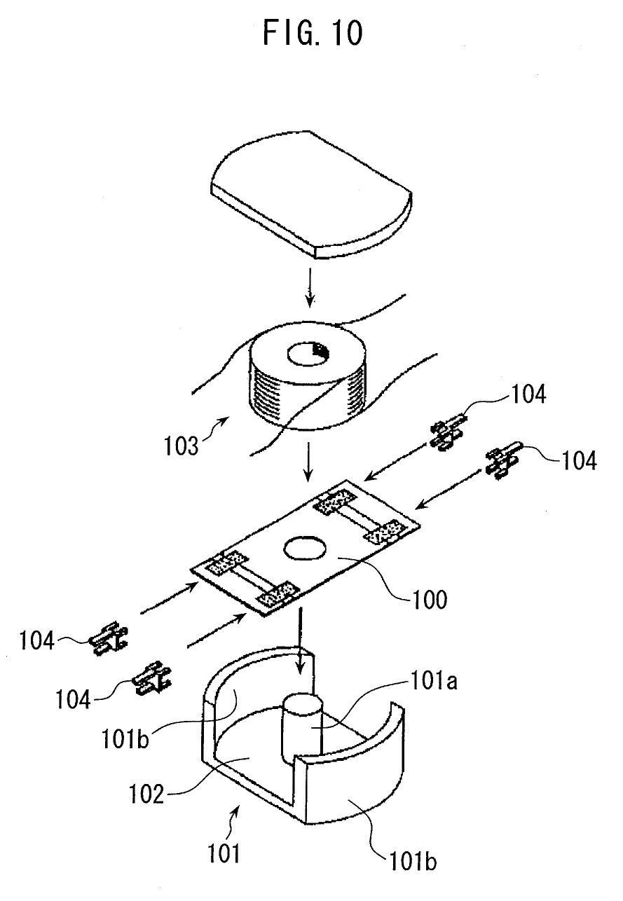

FIG. 9 shows the relationship between the coupling factor and the core gap obtained when the gap between the top surface of the core body 3a of the center-leg-having core 3 and the bottom faces of the side-leg cores 4b of the C-type core 4 changes, with a spacer (not shorten) interposed. In the present invention, in addition to the improvement of the coupling factor owing to the distance between the center-leg core 3b and the coil 6 shortened in proportion to the not interposed winding drum part, the coupling factor can be further improved by distributing the gaps. In the figure, CTR type represents a switching transformer of the present invention and EER type represents a switching transformer in which a gap is provided at the top end of a center-leg core. The switching transformer of the present invention has the advantage that the coupling factor is further improved.

### INDUSTRIAL APPLICABILITY

The present invention can be applied to a small switching transformer used in a power supply device of consumer electronic equipment.

1.-8. (canceled)

9. A method of manufacturing a switching transformer, comprising the steps of:
inserting a center-leg core of a center-leg-having core which has a substantially inverted T-shaped section, into a hole for inserting the center-leg core formed in a center part of a terminal block which has terminals implanted in a lower surface thereof and a substantially flat upper surface, to integrate the terminal block and the center-leg-having core;
winding an insulating tape on the outer circumference of the center-leg core protruding from the upper surface of the terminal block, and winding margin tapes on respective end portions of the center-leg core;
rotating the center-leg core to wind an electric wire between the margin tapes, to mount a coil; and subsequently, assembling the switching transformer by placing, from the upper surface side of the terminal block, a substantially Π-shaped, side-leg-having C-type core having side-leg cores formed on both end portions of a connecting part, making an inner surface of the connecting part abut to a top end surface of the center-leg core, and connecting bottom faces of the side leg cores through a spacer to respective end portions of a top surface of a core body of the center-leg-having core.

10. A switching transformer comprising:
a terminal block which has a substantially flat upper surface, terminals implanted in a side portion of a lower surface, a hole formed in a center portion thereof and a rib formed around the hole;
a substantially-inverted-T-shaped center-leg-having core, having a core body positioned on a lower face of the terminal block, and a center-leg core which is formed on a center part of the core body, inserted through the hole of the terminal block and protruding from the upper surface of the terminal block;
an insulating tape wound around the outer circumference of the center-leg core;
margin tapes wound respectively around both end portions of the center-leg core;
a coil wound between the margin tapes; and
a substantially Π-shaped, side-leg-having C-type core, having a connecting part and side-leg cores formed on respective end portions of the connecting part,
wherein the side-leg-having C-type core is assembled from the upper surface side of the terminal block so as to straddle the coil, bottom surfaces of the side-leg cores are connected through a spacer to respective end portions of a top surface of the core body of the center-leg-having core, and an inner surface of the connecting part is abutted to a top end surface of the center leg core.

11. The switching transformer according to claim 2, wherein a substantially rectangular notch is formed in each end face of the terminal block, each of end portions of the core body of the center-leg-having core is positioned on each of the notches, and each of the bottom surfaces of the side-leg cores is connected to each of the end portions of a core body through a spacer.
